(19) United States
(12) Patent Application Publication
(10) Pub. No.: US 2026/0139750 A1
(43) Pub. Date: May 21, 2026

(54) AIR ADMITTANCE VALVE ASSEMBLY

(71) Applicant: OATEY CO., Cleveland, OH (US)

(72) Inventors: Kai ZHANG, Olmstead Falls, OH (US); Angel O. CABAN, Cleveland, OH (US); Christopher Douglas DODD, Cleveland, OH (US)

(21) Appl. No.: 19/118,990

(22) PCT Filed: Oct. 5, 2023
(86) PCT No.: PCT/US2023/076090

§ 371 Date: Apr. 7, 2025

Related U.S. Application Data
(60) Provisional application No. 63/414,237, filed on Oct. 7, 2022.

(51) Int. Cl. F16K 15/14; E03B 7/07

(52) U.S. Cl. CPC F16K 15/148; E03B 7/075

(57) ABSTRACT

Provided herein are air admittance valve (AAV) assemblies that can include a cap, a body portion that includes a tailpiece and a flange with air intake openings, a flexible washer that can serve as a seal against fluid flow, and push seal for insertion into a pipe or fitting of a drain waste vent (DWV) system.

### CROSS-REFERENCE TO RELATED APPLICATIONS

This application claims the benefit of priority to U.S. Provisional App. No. 63/414,237, filed Oct. 7, 2022, the entire contents of which are incorporated herein by reference.

### TECHNICAL FIELD

The present disclosure pertains to air ventilation systems for use in venting of drain, waste, and vent systems.

### BACKGROUND

Typical plumbing systems supply water and carries away waste. Water is supplied under pressure to the plumbing fixtures and drain pipes carry waste water from the fixtures to the main drain which empties into a sewer system, septic tank or the like. Ambient atmospheric pressure is typically maintained in the drainage system and gases may be vented from the system by vent pipes that extend through the roof of the building structure. A drainage system may be referred to as the drain-waste-vent system (or DWV) in that it drains water, carries away solid waste, and vents gasses outside the system. Each plumbing fixture typically has a trap which contains water to prevent gasses from entering the building through the fixture, e.g., sink or tub. The trap of a typical fixture is connected to a drain pipe, which can have, for example, a 1½ or 2 inch diameter. Waste from toilets is typically discharged through a 3 or 4 inch diameter soil pipe connected to the main drain.

At each trap of a fixture a vent extends from the drainage system to maintain atmospheric pressure. Other fixtures are typically vented by a secondary vent or revent, i.e., 1½ inch diameter pipe which is connected to the main vent or they may be vented by a main vent extending through the roof.

Venting a plumbing system allows make-up air to enter the system to prevent a vacuum from forming which would pull water from the traps and into the drain pipes. Thus, plumbing systems typically have at least one main vent and preferably a vent at each fixture. Plumbing codes usually specify the requirements for venting plumbing installations.

It is presently common procedure in the construction and plumbing industries to utilize roof vent pipes for providing make up air when negative pressures are realized in drain and waste plumbing systems, such as when a sink is drained or a toilet is flushed. The installation of vent pipes, particularly secondary vents, is a time consuming and costly procedure in the building construction process. Particularly in home remodeling projects, for example, vent pipes are normally placed within the interior of wall structures and extend to the main vent or through the roof. Further, where wall space restrictions exist, such as in pre-manufactured homes, mobile homes and in other motor vehicles having plumbing drain and waste systems, vent pipes are cumbersome and difficult to install and utilize.

Building codes in several countries outside the United States permit the use of vent valve assemblies for venting drain and waste systems. Further, several states in geographic areas in the United States also permit the use of vent valve assemblies for venting drain and waste systems. However, various codes and requirements must be met for use of such valve assemblies.

Valve assemblies that reliably vent into low pressure plumbing drain and waste systems are needed.

### SUMMARY

Provided herein are air admittance valve assemblies comprising:
a cap (2) that includes
   (i) a top side (4),
   (ii) an underside (6),
   (iii) a cap wall (8) having a top end that extends from an outer periphery of the top side, a bottom edge (10) that defines a terminal end of the cap wall, an inner radial face (12), and an outer radial face (14), and
   (iv) a lattice (16) comprising lattice struts (18), lattice openings (19) representing void spaces between the lattice struts, a top edge (20) that extends from the underside (6) of the cap, a bottom edge (22) that is spaced apart from the top edge, and a lattice wall (24) extending between the top edge (20) and the bottom edge (22), the lattice (16) extending about the underside of the cap concentrically with the cap wall:
a body portion (24) that includes
   (i) a tailpiece (25) that includes a bottom end (26), a top end (28), and a middle portion extending between the bottom end and the top end, the tailpiece having a diameter that is sized for insertion into a pipe or fitting of a drain, waste, and vent system, and
   (ii) a flange (30) extending radially from the top end of the tailpiece, wherein the flange comprises a top surface, a bottom surface, an edge (31) extending between the top surface and the bottom surface, a cap seat (32) positioned at an outer periphery of the top surface adjacent to the edge for engaging the bottom edge (10) of the cap wall (8) in a sealing manner, and an air intake comprising air intake ribs (34), air intake openings (36) extending through the flange from the bottom surface to the top surface and defined as void spaces between air intake ribs, at least some of the air intake ribs (34) including valve seat members (38) at the top surface of the flange;
and,
a flexible washer (40) having bottom face, a top face, an outer concentric edge extending between the top and bottom faces, and an inner concentric edge that defines a central void and extends between the top and bottom faces,
wherein when a pressure inside of the tailpiece is not less than an ambient pressure outside of the air admittance valve assembly, the flexible washer is seated on the top surface of the flange, such that the bottom face of the flexible washer contacts the valve seat members and thereby prevents fluid communication between the inside of the tailpiece and the ambient environment outside of the air admittance valve assembly via the air intake openings of the flange,
and,
wherein when a pressure inside of the tailpiece is less than an ambient pressure outside of the air admittance valve assembly, the flexible washer is raised in a direction that is guided by contact of the outer concentric edge with the inner radial face of the cap wall, that is guided by contact of the inner concentric edge with lattice wall, or both, and thereby permits fluid communication between the inside of the tailpiece and the ambient environment outside of the air admittance valve assembly via the air intake openings of the flange.

Also disclosed herein are air admittance valve assemblies comprising:
a cap that includes
   (i) a top side,
   (ii) an underside, and,
   (iii) a cap wall having a top end that extends from an outer periphery of the top side, a bottom edge that defines a terminal end of the cap wall, an inner radial face, and an outer radial face,
a body portion that includes
   (i) a tailpiece that includes a bottom end, a top end, and a middle portion extending between the bottom end and the top end, the tailpiece having a diameter that is sized for insertion into a pipe or fitting of a drain, waste, and vent system, and
   (ii) a flange extending radially from the top end of the tailpiece, wherein the flange comprises a top surface, a bottom surface, an edge extending between the top surface and the bottom surface, a cap seat positioned at an outer periphery of the top surface adjacent to the edge for engaging the bottom edge of the cap wall in a sealing manner, and an air intake comprising air intake ribs, air intake openings extending through the flange from the bottom surface to the top surface and defined as void spaces between air intake ribs, at least some of the air intake ribs including valve seat members at the top surface of the flange;
a flexible washer having bottom face, a top face, an outer concentric edge extending between the top and bottom faces, and an inner concentric edge that defines a central void and extends between the top and bottom faces.
and,
a push seal that is mounted on the bottom end of the tailpiece and comprises
   (i) a first set of sealing ribs positioned at a distal portion of the push seal, each of said first set of sealing ribs extending radially from the tailpiece to define a first sealing diameter that ensures a fluid seal between the first set of sealing ribs and an inner surface of a pipe or fitting of a drain, waste, and vent system having a first inner diameter when the tailpiece is inserted therein:
   (ii) a second set of sealing ribs positioned at a proximal portion of the push seal, each of said second set of sealing ribs extending radially from the tailpiece to define a second sealing diameter that is greater than the first sealing diameter and ensures a fluid seal between the second set of sealing ribs and an inner surface of a pipe or fitting of a drain, waste, and vent system having a second inner diameter that is greater than the first inner diameter when the tailpiece is inserted therein,
wherein when a pressure inside of the tailpiece is not less than an ambient pressure outside of the air admittance valve assembly, the flexible washer is seated on the top surface of the flange, such that the bottom face of the flexible washer contacts the valve seat members and thereby prevents fluid communication between the inside of the tailpiece and the ambient environment outside of the air admittance valve assembly via the air intake openings of the flange.
and,
wherein when a pressure inside of the tailpiece is less than an ambient pressure outside of the air admittance valve assembly, the flexible washer is raised in a direction that is guided by contact of the outer concentric edge with the inner radial face of the cap wall, that is guided by contact of the inner concentric edge with lattice wall, or both, and thereby permits fluid communication between the inside of the tailpiece and the ambient environment outside of the air admittance valve assembly via the air intake openings of the flange.

Also disclosed herein are air admittance valve assemblies that comprise
a cap that includes
   (i) a top side,
   (ii) an underside, and,
   (iii) a cap wall having a top end that extends from an outer periphery of the top side, a bottom edge that defines a terminal end of the cap wall, an inner radial face, and an outer radial face,
a body portion that includes
   (i) a tailpiece that includes a bottom end, a top end, and a middle portion extending between the bottom end and the top end, the tailpiece having a diameter that is sized for insertion into a pipe or fitting of a drain, waste, and vent system, and
   (ii) a flange extending radially from the top end of the tailpiece, wherein the flange comprises a top surface, a bottom surface, an edge extending between the top surface and the bottom surface, a cap seat positioned at an outer periphery of the top surface adjacent to the edge for engaging the bottom edge of the cap wall in a sealing manner, and an air intake comprising air intake ribs, air intake openings extending through the flange from the bottom surface to the top surface and defined as void spaces between air intake ribs, at least some of the air intake ribs including valve seat members at the top surface of the flange;
and,
a flexible washer having bottom face, a top face, an outer concentric edge extending between the top and bottom faces, and an inner concentric edge that defines a central void and extends between the top and bottom faces,
wherein when a pressure inside of the tailpiece is not less than an ambient pressure outside of the air admittance valve assembly, the flexible washer is seated on the top surface of the flange, such that the bottom face of the flexible washer contacts the valve seat members and thereby prevents fluid communication between the inside of the tailpiece and the ambient environment outside of the air admittance valve assembly via the air intake openings of the flange.
wherein when a pressure inside of the tailpiece is less than an ambient pressure outside of the air admittance valve assembly, the flexible washer is raised in a direction that is guided by contact of the outer concentric edge with the inner radial face of the cap wall, that is guided by contact of the inner concentric edge with lattice wall, or both, and thereby permits fluid communication between the inside of the tailpiece and the ambient environment outside of the air admittance valve assembly via the air intake openings of the flange,
and,
wherein the total area of the air intake openings of the flange is greater than or equal to the cross-sectional area of the tailpiece.

### BRIEF DESCRIPTION OF THE DRAWINGS

FIGS. 1A and 1B provide side and cross-sectional views, respectively, of an embodiment of a fully assembled air admittance valve (AAV) assembly according to the present disclosure.

FIG. 2 provides an exploded view of an embodiment of the assembly, in which the separate components of the assembly are shown individually.

FIG. 3A provides a side view of a further embodiment of an inventive AAV assembly. FIG. 3B provides a side view of a cap portion of an inventive AAV assembly.

FIGS. 4A-4D provide views of a further embodiment of an inventive AAV assembly or components thereof, that include stop tabs on the tailpiece, and FIG. 4E depicts a mechanical coupling that can be used in place of a push seal.

FIGS. 5A-5G respectively provide cross-sectional views of different exemplary push seal components according to the present disclosure.

FIG. 6 depicts exemplary AAV assemblies, with caps and push seals being prominently visible.

FIG. 7 provides cross-sectional views of body portions, including exemplary inner and outer diameters.

FIG. 8 provides cross-sectional views of body portions, including exemplary inner and outer diameters.

FIGS. 9A and 9B shows cross-sectional views of the flexible washer in the closed position and resting on the valve seat.

FIG. 10 provides a cross-sectional view of a complete AAV assembly according to the present disclosure.

FIG. 11 provides a side view of a fully assembled AAV.

FIG. 12 provides a cross-sectional view of a complete AAV assembly according to the present disclosure.

FIG. 13 provides a side view of a fully assembled AAV.

FIG. 14 provides a cross-sectional view of a complete AAV assembly according to the present disclosure.

FIG. 15 provides a side view of a fully assembled AAV.

FIG. 16 provides a cross-sectional view of a complete AAV assembly according to the present disclosure.

FIG. 17 provides a side view of a fully assembled AAV.

FIG. 18 provides a cross-sectional view of a complete AAV assembly according to the present disclosure, including a push seal that comprises two sets of sealing ribs.

FIG. 19 provides a cross-sectional view of a body portion according to the present invention.

FIG. 20 shows an exemplary body portion according to the present invention as viewed from below, such that the air intake ribs and air intake openings are visible.

FIG. 21 shows an exemplary body portion according to the present invention as viewed from above, in which the air intake ribs and air intake openings are also visible.

FIG. 22 depicts an exemplary cap with a lattice.

FIG. 23 provides a cross-sectional view of an exemplary cap with a lattie.

FIG. 24 provides a cross-sectional view of a cap with a lattice assembled with an exemplary body portion.

FIG. 25 provides a cross-sectional view of an exemplary body portion with a flexible washer resting on the valve seats thereof.

FIG. 26 provides a cross-sectional view of an exemplary body portion assembled with a cap, and a flexible washer in a partially raised position.

FIG. 27 shows an exemplary body portion.

FIGS. 28A-28C respectively provide exploded views of the cap, lattice, flexible washer, body portion, and push seal components of exemplary inventive AAV assemblies.

FIG. 29 provides an exploded view of the cap, lattice, flexible washer, body portion, and push seal components of an exemplary inventive AAV assembly.

FIG. 30 provides a cross-sectional view of an exemplary push seal featuring two sets of sealing ribs and an annular groove for accepting the lower end of a tailpiece.

FIG. 31 illustrates an exemplary push seal featuring two sets of sealing ribs and a pipe sealing rib.

FIG. 32 illustrates an exemplary push seal featuring two sets of sealing ribs and a pipe sealing rib

FIG. 33 provides an exploded underside view of the cap and lattice, flexible washer, body portion, and push seal components of an exemplary inventive AAV assembly.

FIG. 34 provides a cross-sectional view of an exemplary inventive AAV assembly installed on the upper end of a pipe having an inner diameter into which a first set of sealing ribs of the AAV assembly fits in order to form a seal.

FIG. 35 provides a side view of an exemplary AAV assembly installed on the upper end of a AU 100 mm diameter pipe into which a first set of sealing ribs of the AAV assembly fits in order to form a seal.

FIG. 36 provides a cross-sectional view of an exemplary inventive AAV assembly installed on the upper end of a pipe having an inner diameter into which a first set of sealing ribs of the AAV assembly fits in order to form a seal.

FIG. 37 provides a side view of an exemplary AAV assembly installed on the upper end of a TW 100 mm diameter pipe into which a first set of sealing ribs of the AAV assembly fits in order to form a seal.

FIG. 38 provides a cross-sectional view of an exemplary inventive AAV assembly installed on the upper end of a pipe having an inner diameter into which a second set of sealing ribs of the AAV assembly fits in order to form a seal, and over whose top edge a pipe seal rib extends.

FIG. 39 provides a side view of an exemplary inventive AAV assembly installed on the upper end of a TW 120 mm pipe into which a second set of sealing ribs of the AAV assembly fits in order to form a seal, and over whose top edge a pipe seal rib extends.

FIG. 40 provides a cross-sectional view of an exemplary inventive AAV assembly installed on the upper end of a pipe.

FIG. 41 provides a side view of an exemplary inventive AAV assembly installed on the upper end of a TW 80 mm pipe.

FIG. 42 provides a cross-sectional view of an exemplary inventive AAV assembly installed on the upper end of a pipe.

FIG. 43 provides a side view of an exemplary inventive AAV assembly installed on the upper end of an AU 80 mm pipe.

FIG. 44 provides a side view of an exemplary inventive AAV assembly in which the push seal includes two sets of sealing ribs and a pipe sealing rib.

FIG. 45 shows a cross-sectional view of an exemplary body portion of an inventive AAV assembly.

FIG. 46 shows an exemplary body portion according to the present invention as viewed from below, such that the air intake ribs and air intake openings are visible.

FIGS. 47A-47C provide various views of exemplary body portions according to the present disclosure that respectively include a lattice seat.

FIG. 48 is a cross-sectional view of an inventive cap with a lattice, and a flexible washer in the resting (lowered) position.

FIG. 49 provides a cutaway perspective view of an inventive cap with a lattice, and a flexible washer in the resting (lowered) position.

FIG. 50 provides a cross-sectional view of an exemplary cap with a lattice, a body portion, and a flexible washer positioned on the valve seat members. i.e., in the resting position.

FIG. 51 depicts a cross-sectional view of an inventive body portion with a flexible washer positioned on the valve seat members of the body portion.

FIG. 52 provides a cross-sectional view of an exemplary cap with a lattice, a body portion, and a flexible washer in a partially raised position.

FIG. 53 provides a perspective view of an exemplary body portion according to the present invention.

FIG. 54 is a cross-sectional view of an exemplary push seal that includes two sets of sealing ribs, a pipe-sealing rib, and an annular groove for accommodating the bottom end of a tailpiece of a body portion.

FIG. 55 is a perspective view of an exemplary push seal that includes two sets of sealing ribs, a pipe-sealing rib.

FIGS. 56A and 56B respectively provide a perspective view and cross-sectional view of a lattice that comprises a lip at the lower end thereof.

FIG. 57A depicts the assembly of a flexible washer with a rigid carrier ring, and FIG. 57B provides a cutaway perspective view of an inventive AAV assembly in which the flexible washer and carrier ring are installed.

FIG. 58A depicts a cutaway perspective view of the assembly of a flexible washer with support rings adjacent the inner circumferential edge and the outer circumferential edge of the flexible washer, and FIG. 58B provides a cutaway perspective view of an inventive AAV assembly in which the flexible washer and support rings are installed.

FIGS. 59A-59D depict embodiments of an exemplary tailpiece that includes external threads that can be used to affix the lower end of the tailpiece to a spigot connector, or to a solvent weld adaptor that can itself be attached to a pipe or fitting of a DWV system.

### DETAILED DESCRIPTION OF ILLUSTRATIVE EMBODIMENTS

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements.

When values are expressed as approximations, by use of the antecedent “about.” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive; as another example, the phrase “about 8%” preferably refers to a value of 7.2% to 8.8%, inclusive. Where present, all ranges are inclusive and combinable. For example, when a range of “1 to 5” is recited, the recited range should be construed as optionally including ranges “1 to 4”, “1 to 3”, “1-2”, “1-2 & 4-5”, “1-3 & 5”, and the like. In addition, when a list of alternatives is positively provided, such a listing can also include embodiments where any of the alternatives may be excluded. For example, when a range of “1 to 5” is described, such a description can support situations whereby any of 1, 2, 3, 4, or 5 are excluded; thus, a recitation of “1 to 5” may support “1 and 3-5, but not 2”, or simply “wherein 2 is not included.” The phrase “at least about x” is intended to embrace both “about x” and “at least x”. It is also understood that where a parameter range is provided, all integers within that range, and tenths thereof, are also provided by the invention. For example, “2-5 hours” includes 2 hours, 2.1 hours, 2.2 hours, 2.3 hours, etc., up to 5 hours

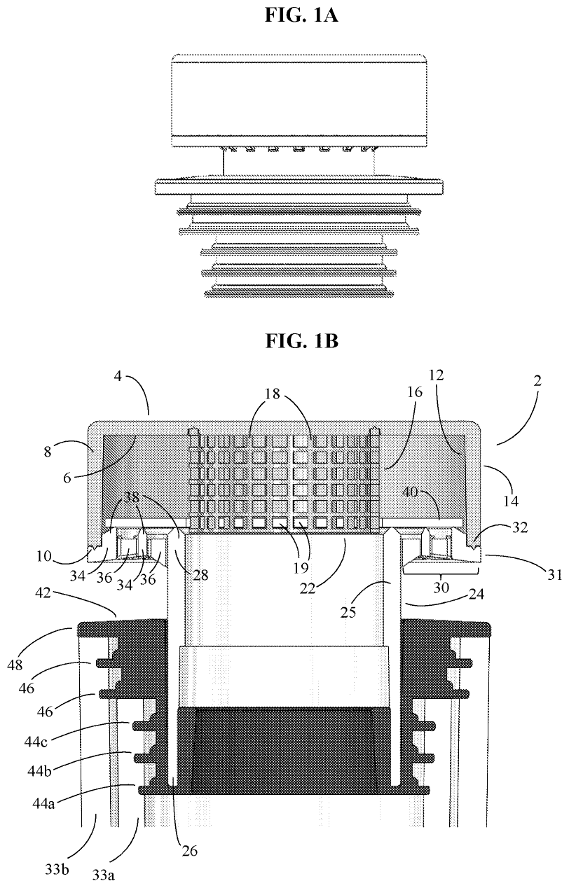

FIG. 1A shows a side external view, FIG. 1B depicts a side cross-sectional view; and FIG. 1C shows an exploded view of an air admittance valve (AAV) assembly 1 according to the present disclosure. As shown, air admittance valve assembly 1 includes a cap 2, a body portion 24, a flexible washer 40 that functions as a valve, and a push seal 42. Body portion 24 includes a tailpiece 25 and a flange 30 extending radially from the top of the tailpiece. These basic components AAV assembly 1 are arranged as follows. Flexible washer 40 is positioned on a top surface of flange 30, and cap 2 fits over the top surface of flange 30. Push seal 42 includes an annular central opening through which tailpiece 25 is inserted. FIG. 1C depicts the cap 2, flexible washer 40, body portion 24, and push seal 42 pre-assembly, and FIGS. 1A and 1B depict these components in their as-assembled configuration.

Cap 2 includes a top side 4, and an underside 6. Cap 2 further comprises a cap wall 8 having a top end that extends from an outer periphery of the top side, a bottom edge 10 that defines a terminal end of the cap wall, an inner radial face 12, and an outer radial face 14. The cap is preferably sized so that it has an outer diameter that is substantially the same as that of the flange 30 of body portion 24. The horizontal cross-sectional shape of cap 2 is preferably circular, and in any event is configured to conform to the shape of flange 30. When fitted against flange 30, the bottom edge 10 of cap 2 forms a fluid seal so that air is substantially prevented from entering into or exiting from between the bottom edge 10 and the top surface of flange 30. As described more fully herein, air flow to or from the interior of body portion 24 is generally restricted by the configuration of AAV assembly 1 to specified portions of the device.

Cap 2 or any subcomponent thereof (such as lattice 16) may be formed from any rigid material, such as a thermoplastic polymer, including, for example, polyvinyl chloride (PVC), polyvinyl acetate (PVA), or acrylonitrile butadiene styrene (ABS).

Cap 2 comprises a lattice 16 that, in the assembled form of AAV assembly 1, extends from the underside 6 of cap to a point where it contacts cap seat 32 of flange 30. Lattice 16 includes struts 18 and openings 19, the latter representing void spaces between the struts 18. Lattice 16 can function as a barrier against the intrusion of insects from the drain, waste, and vent (DWV) system and out of AAV assembly 1, and accordingly the individual openings 19 are preferably sized in order to be too small to allow passage of insect species that are most likely to attempt to exit a DWV system.

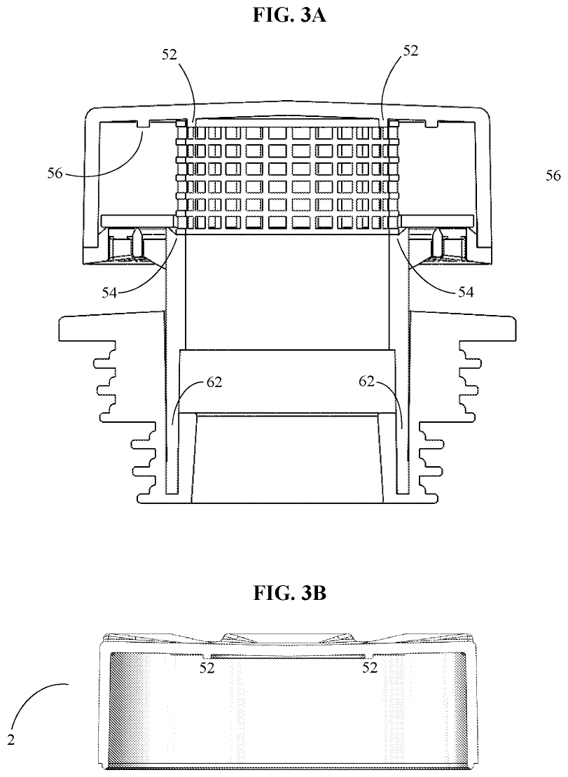

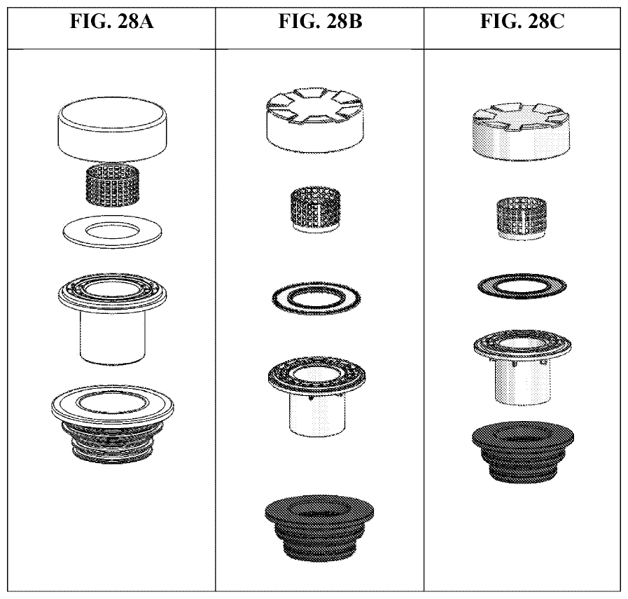

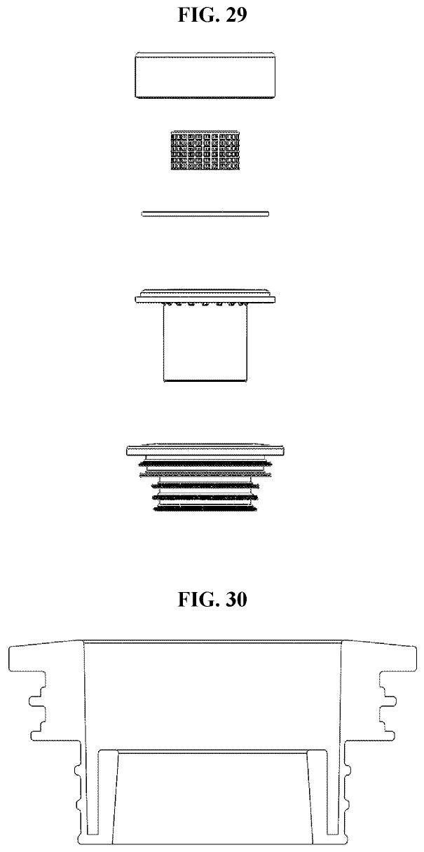

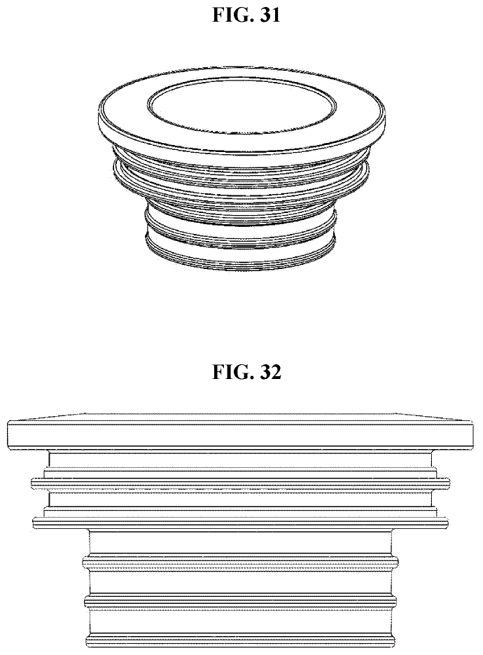

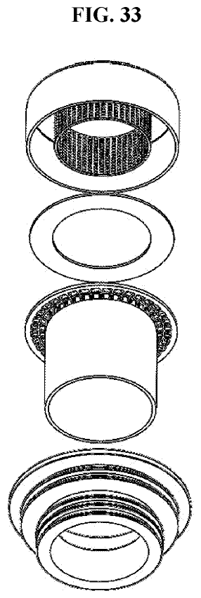

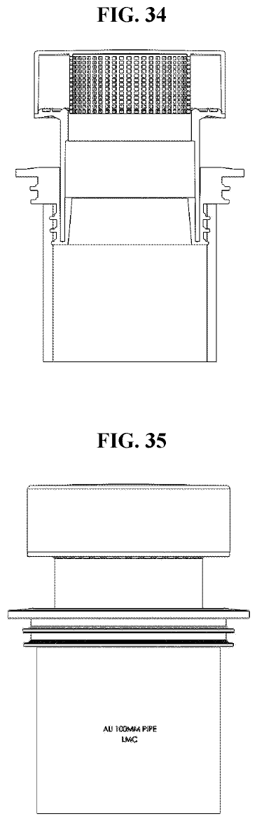

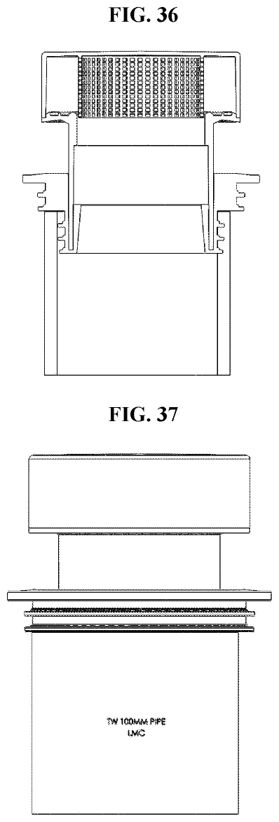

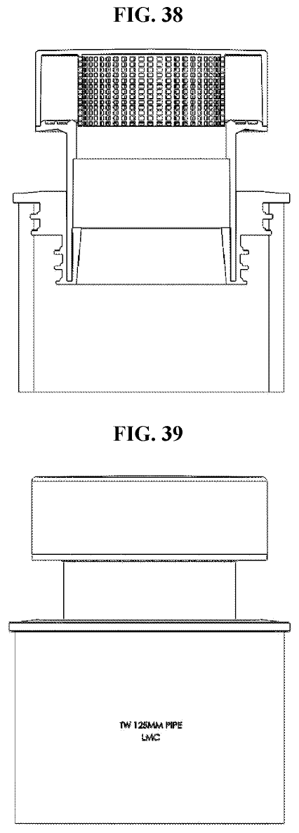

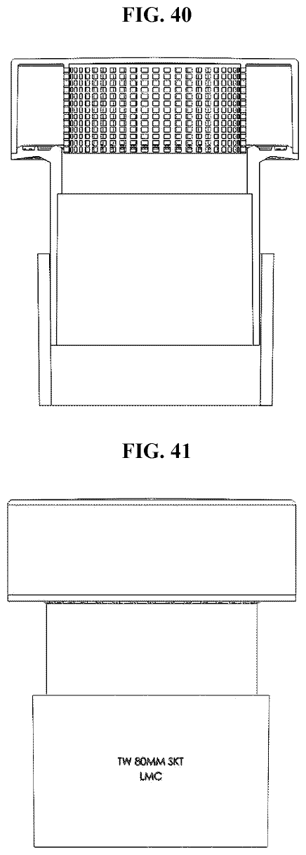

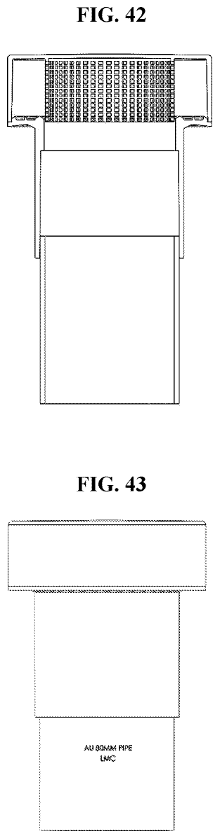

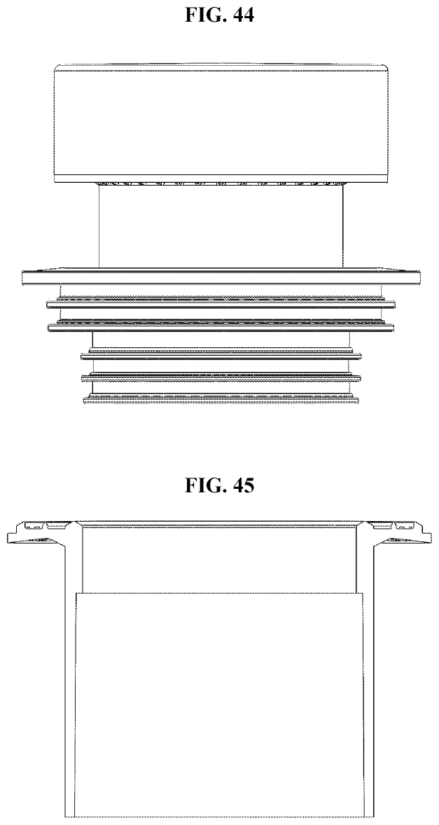

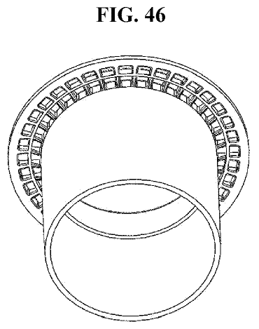

In some embodiments, lattice 16 is integral with the underside 6 of cap 2. This can mean that the lattice 16 is formed integrally with the underside 6 of cap 2, or that the lattice 16 snaps securely into recesses or onto ridges on the underside 6 of cap 2. In other embodiments, lattice 16 merely abuts the underside 6 of cap 2. FIGS. 28A-28C depict embodiments in which lattice 16 is not integral with cap 2. Throughout the present disclosure, when stating that the cap includes or comprises a lattice, this is intended to embrace embodiments in which the lattice and cap are provided as distinct components (e.g., manufactured as separate components) but can be physically adjoined to one another when the AAV assembly is in the assembled state. As shown in FIG. 3A, underside 6 of cap 2 may include a ring-shaped ridge 52 that is concentric with the top edge 20 of lattice 16, and that is sized so that it lattice 16 fits snugly around the ridge 52. In this manner, ridge 52 ensures that lattice 16 is properly centered at the underside 6 of cap 2. FIG. 3B provides a further view of cap 2 featuring a ridge 52.

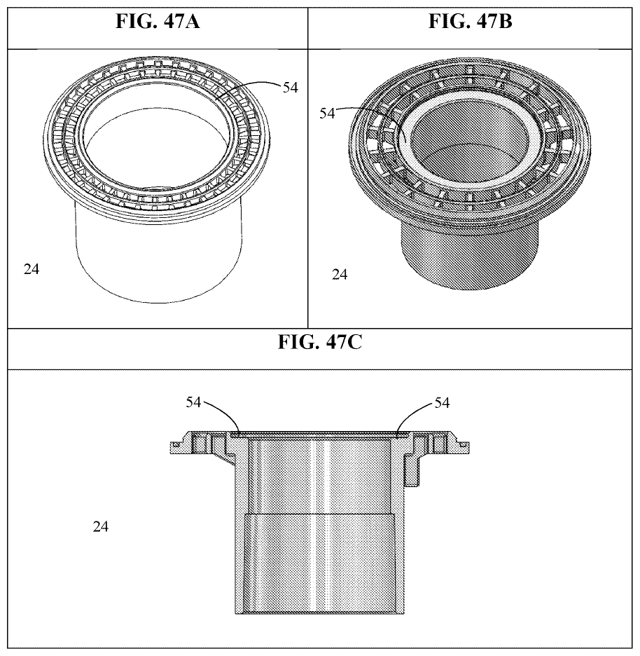

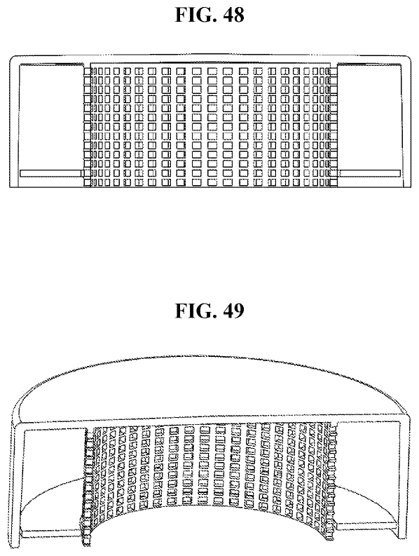

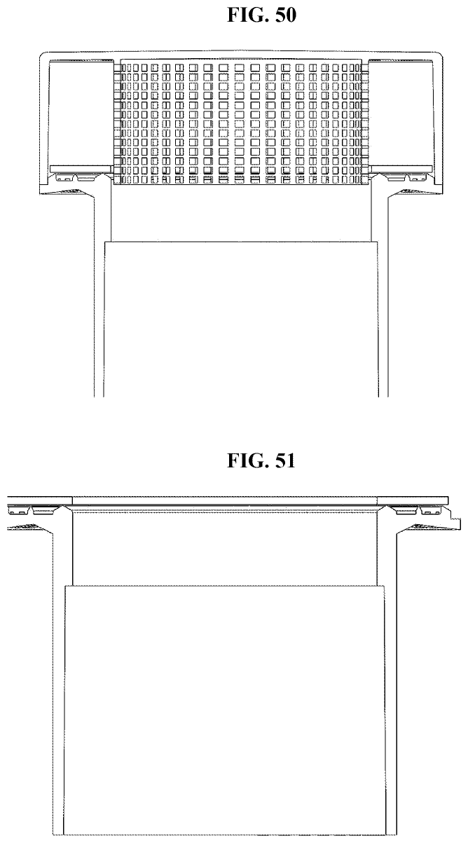

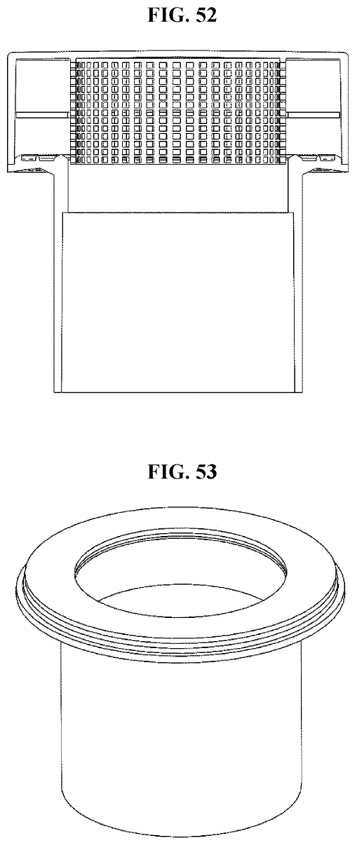

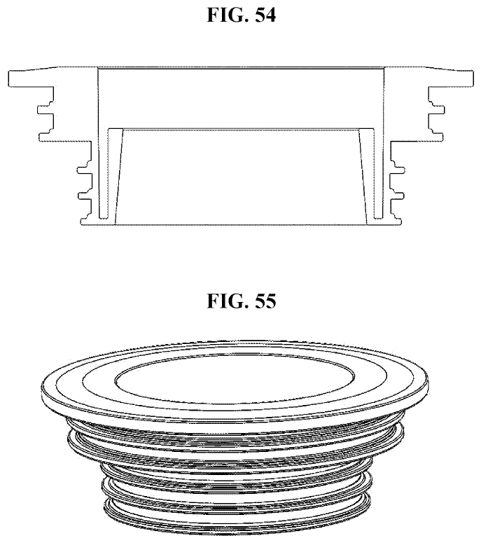

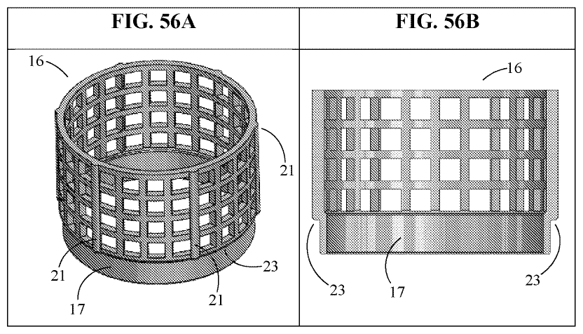

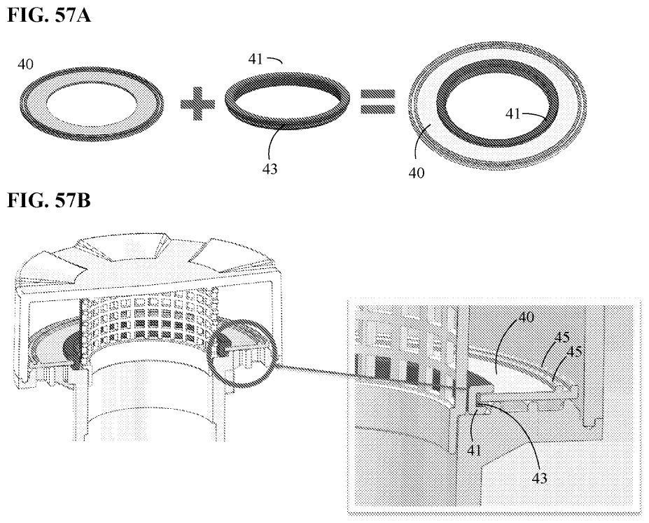

In some embodiments, lattice 16 includes a lip 17 that extends from the portion of lattice 16 that includes struts 18 and openings 19, wherein lip 17 defines a portion of lattice 16 that is seated against a top surface of flange 30 when AAV assembly 1 is in the assembled state. FIGS. 56A and 56B provide perspective and cross-sectional views of lattice 16 featuring a lip 17. In these embodiments, lip 17 extends circumferentially about the base of lattice 16 and has a smaller diameter than lattice 16, thereby defining a circumferential ledge 23 at the point where the lip 17 meets the portion of lattice 16 that includes struts 18 and openings 19. The ledge 23 is configured for seating on a portion of the top surface of flange 30 of body portion 24. As described below and as depicted in FIG. 3, body portion 24 may include a lattice seat 54 against which the bottom edge 22 of lattice may rest when the cap 2 and lattice 30 are in the assembled configuration with body portion 24. Lattice seat 54 may also be configured so that ledge 23 rests on lattice seat 54. FIGS. 47A-47C depict embodiments of body portion 24 that include a lattice seat 54 that on which ledge 23 may rest when AAV assembly 1 is in the assembled state. FIG. 57B also shows how ledge 23 rests on lattice seat 54.

In certain embodiments, one or more vertically oriented lattice ribs 21 may be positioned circumferentially about the outer face of lattice 16. Lattice ribs 21 can provide spacing between the outer face of lattice 16 and the inner concentric edge of the flexible washer 40 when AAV assembly 1 is in the assembled state. The spacing between the outer face of lattice 16 and the inner concentric edge of the flexible washer 40 can be useful for preventing flexible washer 40 from becoming stuck on or improperly oriented relative to outer face of lattice 16 as flexible washer 40 moves from the seated position on the top face of flange 30 to the raised position, or as flexible washer 40 moves from the raised position back to the seated position on the top face of flange 30. FIG. 56A depicts an embodiment wherein lattice 16 includes lattice ribs 21. Throughout the present disclosure, when it is stated that the flexible washer 40 is raised or lowered in a direction that is guided by contact of the inner concentric edge of flexible washer 40 with the lattice wall, the phrase “lattice wall” can refer to the outer face of lattice wall without ribs, or can refer to the portion of the lattice wall constituting lattice ribs 21. In other words, when lattice ribs 21 are provided on lattice 16, the “lattice wall” that can guide the raising or lowering of the flexible washer 40 can be one or more of the lattice ribs themselves.

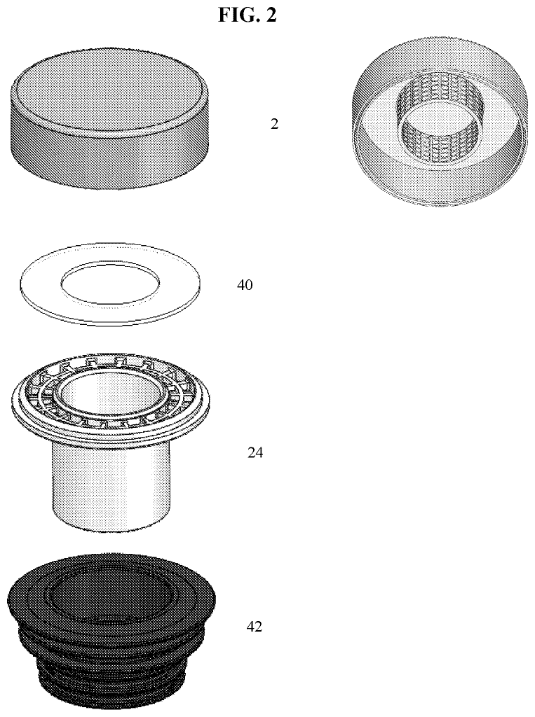

Body portion 24 includes tailpiece 25 and flange 30. As described above, the bottom edge 10 of cap 2 fits against and forms a seal with cap seat 32 at an outer periphery of the top surface of the flange 30. Cap seat 32 of flange 30 can be seen from the exploded view of AAV assembly 1 provided in FIG. 2.

Radially inward of cap seat 32 on flange 30 is an air intake comprising air intake ribs 34 that define air intake openings 36. Air intake openings 36 extend through the flange from its top surface to its bottom surface. The configuration, i.e., the shape and size, of the air intake openings 36 and the air intake ribs 34 are not critical, as long as the openings permit sufficient airflow therethrough when a pressure inside of the tailpiece 25 is less than an ambient pressure outside of the AAV assembly 1 (in which case the flexible washer is raised so that it does not contact air intake ribs 34). The sufficiency of the airflow is defined more fully infra, but in some embodiments, the total area of air intake openings 36 is greater than or equal to the cross-sectional area of the tailpiece.

At the top surface of flange 30, air intake ribs 34 may include valve seat members 38 on which the flexible washer 40 rests when a pressure inside of the tailpiece 25 is not less than an ambient pressure outside of the AAV assembly 1. As depicted in FIGS. 1B and 3, for example, valve seat members 38 may include a taper point for limiting a contact area between the air intake ribs 34 and the flexible washer 40. Nonetheless, even though contact between air intake ribs 34 and the flexible washer 40 is may be limited by the configuration of valve seat members 38, the contact is sufficient for flexible washer 40 to provide a fluid seal when in the at-rest position in order to prevent airflow through air intake openings 36.

As shown in FIG. 3, at the juncture between tailpiece 25 and flange 30 (representing the top end 28 of the tailpiece 25), body portion 24 may include a lattice seat 54 against which the bottom edge 22 of lattice may rest when the cap 2 and lattice 30 are in the assembled configuration with body portion 24. Lattice seat 54 extends around the entire upper face of top end 28, and thereby helps to position lattice 16 against body portion 24.

Flexible washer 40, shown in isolation in FIG. 2, has an outer diameter that is substantially the same as the inner diameter of cap 2 (i.e., the distance between an inner radial face 12 of cap 2 and a directly opposing inner radial face of cap 2), and defines a central void that is substantially the same as the outer diameter of lattice 16. As such, the motion of flexible washer 40 within AAV assembly 1 when in use is guided by contact of the outer concentric edge of the flexible washer 40 with the inner radial face of the cap wall, by contact of the inner concentric edge of the flexible washer 40 with the outer face of the lattice wall 24, or both.

In some embodiments, the underside 6 of cap 2 may include bosses 56 in order to reduce the surface area of contact between the top surface of flexible washer 40 and underside 6 of cap 2. The presence of bosses can prevent flexible washer 40 from sticking to the underside 6 of cap 2 when flexible washer is in the open position (i.e., when flexible washer is raised and no longer contacts air intake ribs 34 because a pressure inside of the tailpiece is less than an ambient pressure outside of the AAV assembly 1). Bosses 56 may adopt any configuration that is effective to reduce the surface area of contact between the top surface of flexible washer 40 and underside 6 of cap 2. In one embodiment, shown in cross-section in FIG. 3, bosses 56 are in the form of a ring-shaped ridge that is concentric with the cap wall 8.

Flexible washer 40 may be formed from any flexible or semi-rigid material that is capable of forming a seal with air intake ribs 34 when flexible washer 40 is in the resting position. Suitable materials include, for example, a natural or synthetic rubber, silicone, neoprene, or any combination thereof. An exemplary synthetic rubber that can be used for the flexible washer is ethylene propylene diene monomer (EPDM).

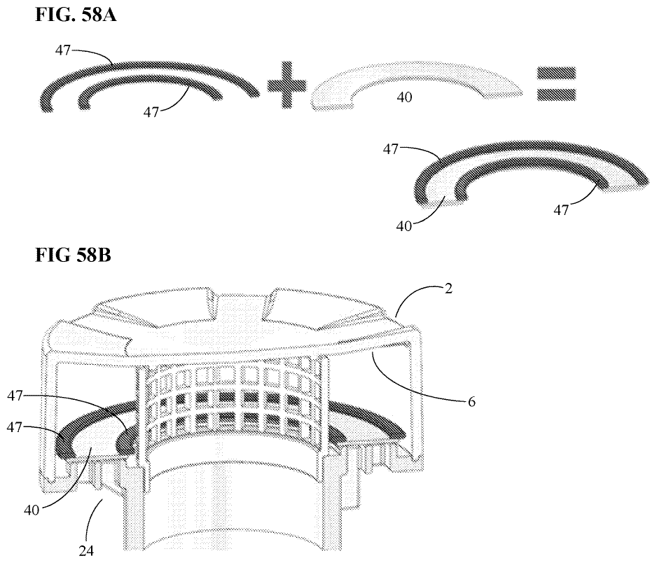

In some embodiments, flexible washer 40 can include a carrier ring 41 that can be removably or permanently affixed to the inner circumferential edge of flexible washer 40. For example, as depicted in FIGS. 57A and 58B, carrier ring 41 can be affixed to flexible washer 40 by housing the inner circumferential edge within a channel 43 of carrier ring 41. Carrier ring 41 is preferably formed from a substantially rigid material (e.g., plastic) that confers rigidity and represents a rigid element of flexible washer 40. Suitable materials for forming the carrier ring 41 include polyvinyl chloride (PVC), polyvinyl acetate (PVA), or acrylonitrile butadiene styrene (ABS), or any combination thereof. Carrier ring 41 can contribute to the ability of flexible washer 40 to avoid deviation from a single spatial plane and maintains a consistent shape during raising and lowering as a result of pressure change within the system, which can in turn ensure that flexible washer 40 functions properly as a seal.

The top face of flexible washer 40 can optionally include one or more upwardly extending and circumferentially arranged ribs 45. FIG. 58B depicts a flexible washer 40 featuring two upwardly extending and circumferentially arranged ribs 45. The ribs 45 may integrally formed with flexible washer 40, or may be formed separately from flexible washer 40 and fixedly attached to flexible washer 40 during assembly. Ribs 45 can prevent flexible washer 40 from sticking to the underside 6 of cap 2 when the flexible washer 40 is in the raised position by creating spacing between the top face of flexible washer 40 and underside 6 of cap 2.

In certain other embodiments, flexible washer 40 can include one or more substantially rigid support rings 47 that are affixed to the top face of flexible washer 40 in order to confer rigidity and represent a rigid element of flexible washer 40. Support rings 47 can contribute to the ability of flexible washer 40 to avoid deviation from a single spatial plane and maintains a consistent shape during raising and lowering as a result of pressure change within the system, which can in turn ensure that flexible washer 40 functions properly as a seal. Support rings may also prevent flexible washer 40 from sticking to the underside 6 of cap 2 when the flexible washer 40 is in the raised position by creating spacing between the top face of flexible washer 40 and underside 6 of cap 2. The support rings 47 may have a substantially flat vertical profile, as shown in FIG. 58A, which depicts cross-sectional views of the flexible washer 40 and support rings 47, and in FIG. 58B, which depicts a cross-sectional view of the flexible washer 40 and support rings 47 positioned within the space defined by the cap 2 and the body portion 24 in an embodiment of the inventive AAV system 1. Suitable materials for forming the support rings 47 include polyvinyl chloride (PVC), polyvinyl acetate (PVA), or acrylonitrile butadiene styrene (ABS), or any combination thereof.

Tailpiece 25 extends downward from flange 30 from a top end 28 thereof to a bottom end 26. The distance between top end 28 and bottom end 26 may be about 30 to about 60 mm, such as about 35 to 55 mm, or about 40 to 50 mm (including, for example, about 35, 36, 37, 38, 39, 40, 41, 42, 43, 44, 45, 46, 47, 48, 49, or 50 mm), or more generally, a length that is sufficient to permit insertion of a portion of tailpiece into a pipe or fitting of a DWV system. The outer diameter of the tailpiece 25 can vary according to the size of the pipe or fitting of a DWV system into which the tailpiece is to be inserted. For example, the outer diameter of the tailpiece may be from about 30 to 150 mm, such as about 30, 35, 40, 45, 50, 55, 60, 65, 70, 75, 80, 85, 90, 95, 100, 105, 110, 115, 120, 125, 130, 135, 140, 145, or 150 mm. The inner diameter of the tailpiece may also vary, and can be from about 25 to 140 mm, such as about 25, 30, 35, 40, 45, 50, 55, 60, 65, 70, 75, 80, 85, 90, 95, 100, 105, 110, 115, 120, 125, 130, 135, or 140 mm. Table 1, below, provides exemplary inner diameters and corresponding outer diameters of specific embodiments.

TABLE 1

| | Inner | Outer |
|---|---|---|
| | Diameter | Diameter |
| Embodiment | (mm) | (mm) |
| 32 mm AU DWV Pipe | 30.0 | 36.3 |
| 40 mm AU DWV Fitting | 43.1 | 47.3 |
| 50 mm AU DWV Fitting | 56.0 | 60.4 |
| 80 mm AU DWV Pipe | 73.0 | 82.3 |
| 100 mm AU DWV Pipe | 98.0 | 110.0 |
| 40 mm TW DWV Fitting | 48.7 | 57.7 |
| 50 mm TW DWV Fitting | 60.8 | 70.6 |
| 80 mm TW DWV Pipe | 83.0 | 89.0 |
| 100 mm TW DWV Pipe | 107.0 | 114.0 |
| 125 mm TW DWV Pipe | 131.0 | 140.0 |

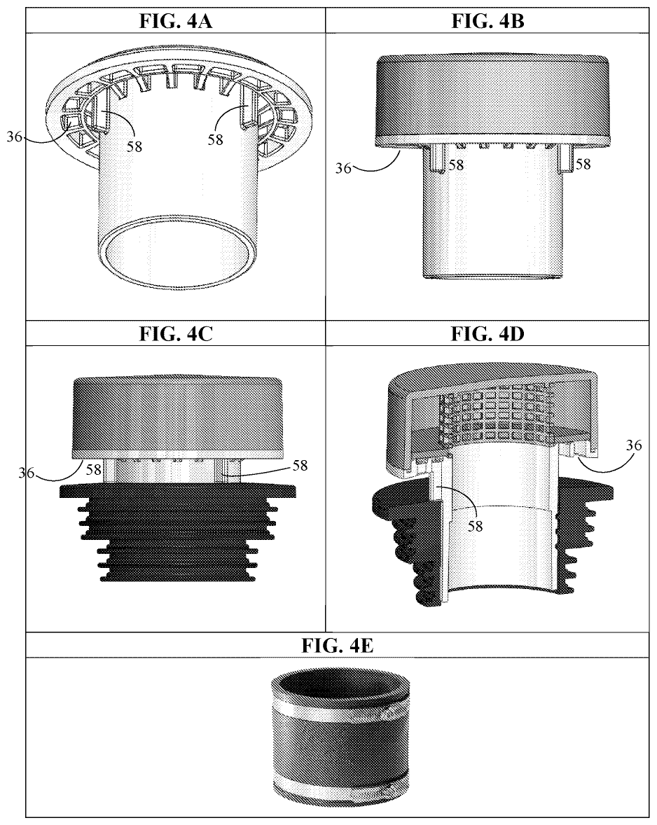

Tailpiece 25 may further comprise one or more stop tabs 58 that are positioned and project radially from the outer surface of the tailpiece 25. FIGS. 4A-4D depict embodiments featuring stop tabs 58 that extend from a bottom surface of flange 30 along a portion of the length of tailpiece 25. As shown in FIGS. 4C and 4D, stop tabs 58 can function to prevent a top side of push seal from obstructing the bottom surface of flange 30, i.e., from blocking air intake openings 36 at the bottom surface of flange 30, when push seal 42 is mounted on the bottom end 26 of tailpiece 25. In other words, stop tabs 58 provide a stop along the length of tailpiece 25 beyond which push seal 42 cannot move. The number of stop tabs 58 that may be provided on the outer surface of tailpiece 25 may be one, two, three, four, five, or more. When there are two or more stop tabs, the individual stop tabs are preferably regularly spaced from one another, although they may alternatively be irregularly spaced. For example, if there are three stop tabs, they are preferably spaced at 120° intervals from one another around the outer surface of tailpiece 25. For users that prefer not to employ a push-in seal of the type provided by push seal 42, a mechanical coupling such as the type depicted in FIG. 4E can be used to couple the tailpiece 24 to a pipe or fitting of a DWV system, and stop tabs 58 can provide a stop along the length of tailpiece 25 beyond which the mechanical coupling cannot move, in order to prevent a top end of the mechanical coupling from obstructing the bottom surface of flange 30, i.e., from blocking air intake openings 36 at the bottom surface of flange 30.

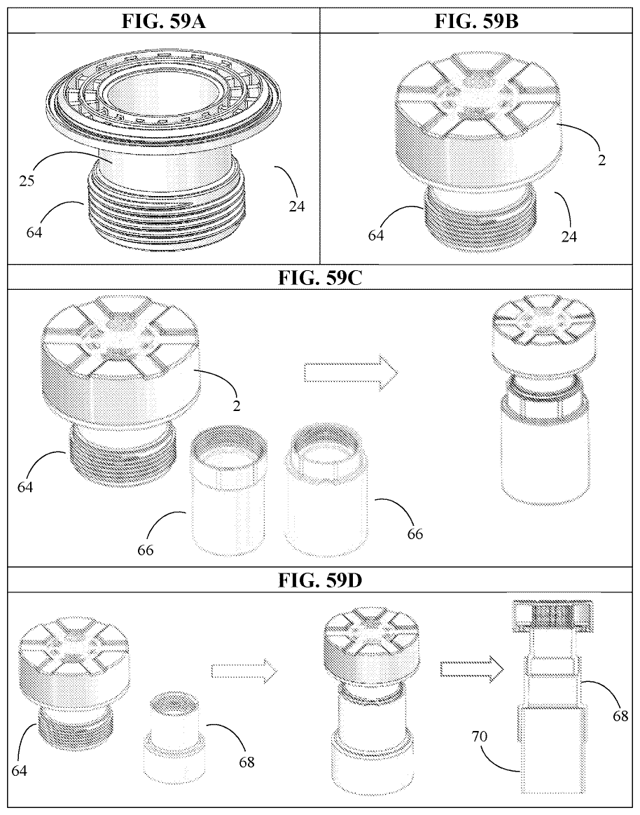

As shown in FIGS. 59A-59D, tailpiece 25 may include external threads 64. FIG. 59A shows a body portion 24 having a tailpiece 25 with external threads 64. FIG. 59B shows a body portion 24 that is assembled with a cap 2, the tailpiece 25 of body portion 24 having external threads 64. Threads 64 can be used to affix the lower end of tailpiece 25 to a spigot connector 66, as show in FIG. 59C, or to a solvent weld adaptor 68 that can itself be attached to a pipe 70 or fitting of a DWV system, as shown in FIG. 59D. Generally speaking, embodiments of tailpiece 25 that include external threads 64 are intended for users that prefer not to employ a push-in seal of the type provided by push seal 42. However, threaded tailpieces may also be compatible with the use of a push-in seal, such as push seal 42.

Push seal 42 defines an inner channel having a circular cross-section into which tailpiece 25 is inserted when AAV assembly 1 is assembled. The inward facing surface of inner channel forms seal against the outer surface of tailpiece 25 when the latter is inserted into the inner channel. As shown in the embodiments of push seal 42 depicted in FIGS. SA-5D, the inner channel may include one or more ridges 60 that can ensure the seal against the outer surface of tailpiece 25.

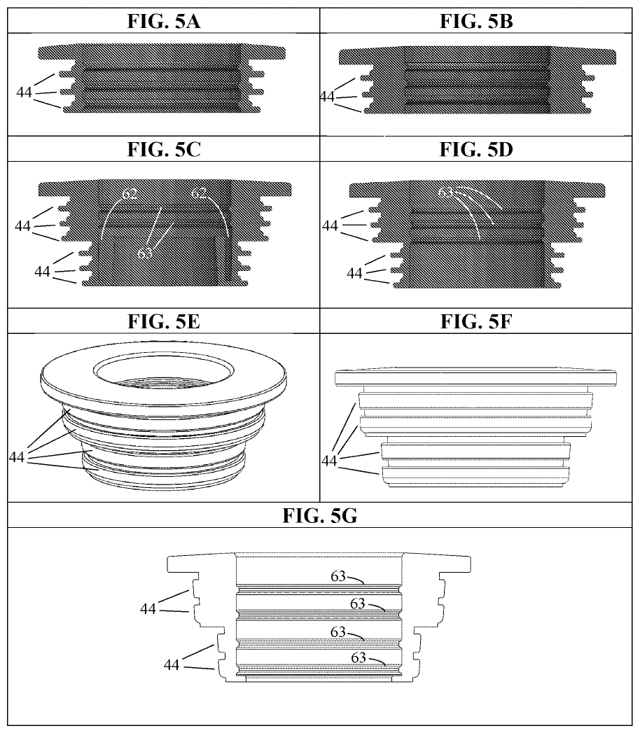

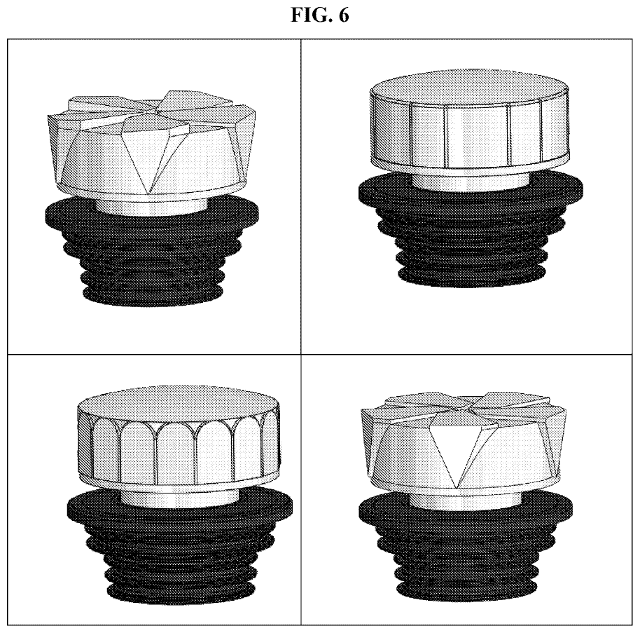

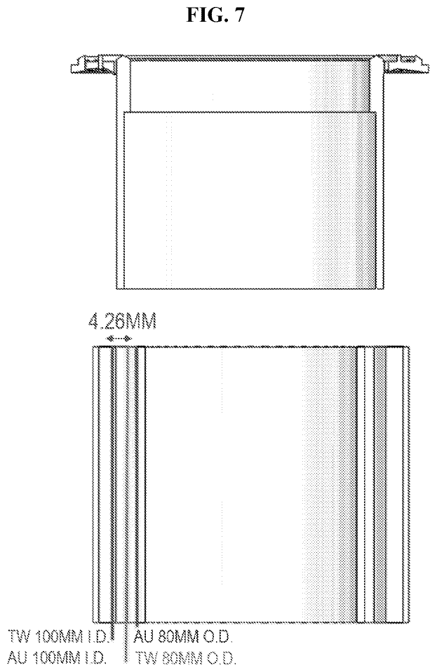

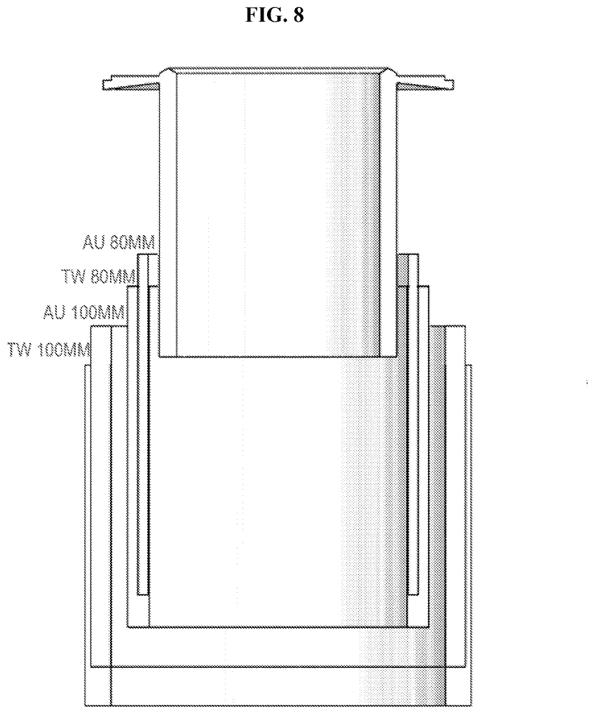

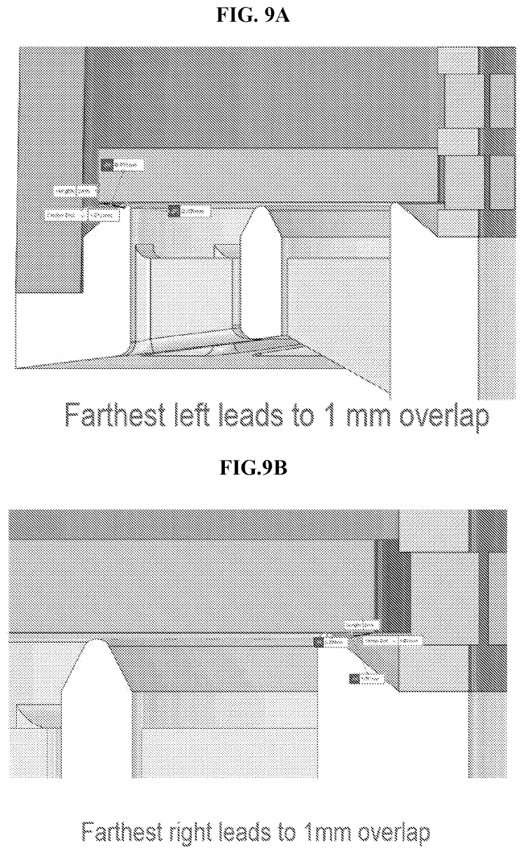

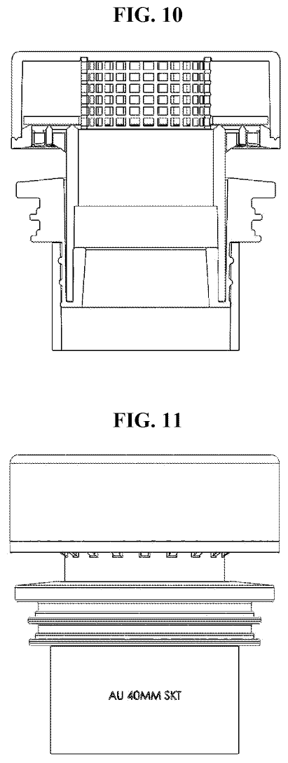

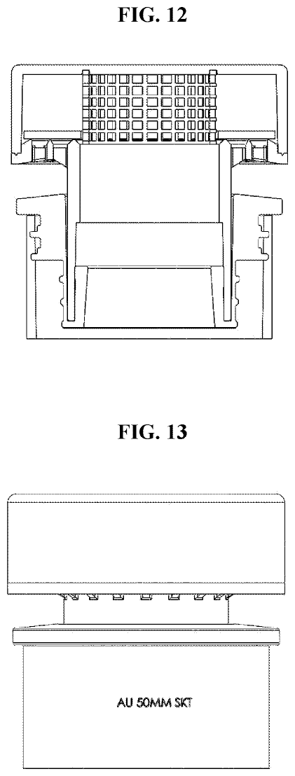

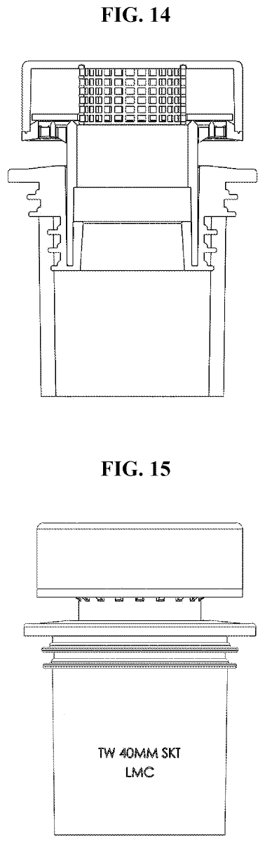

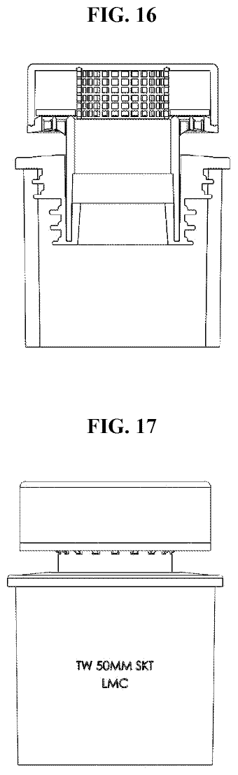

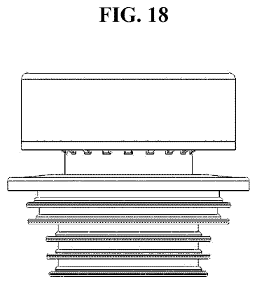

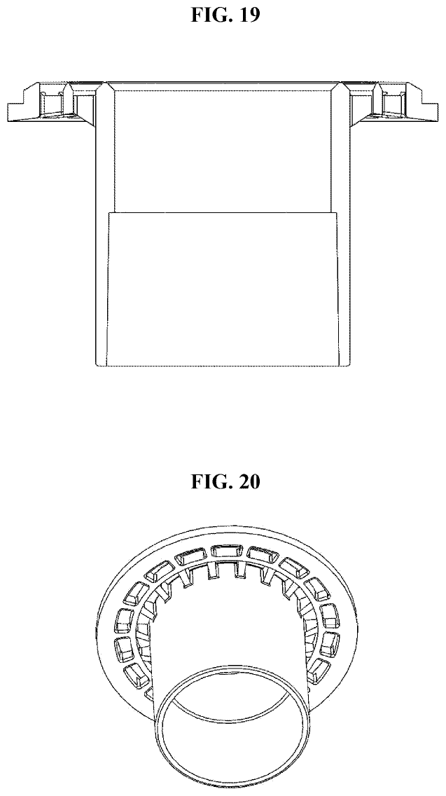

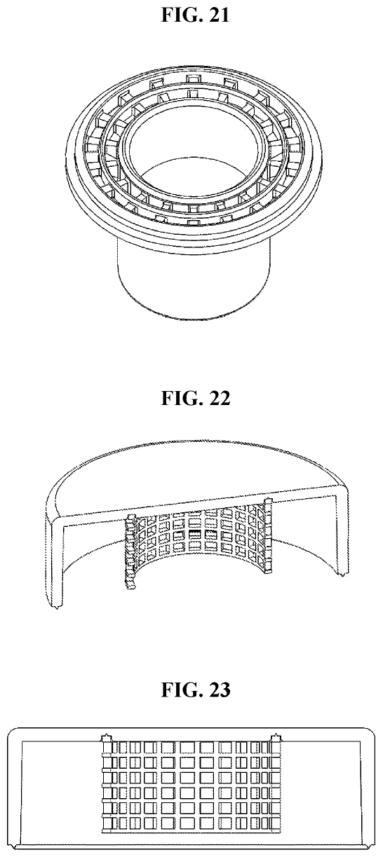

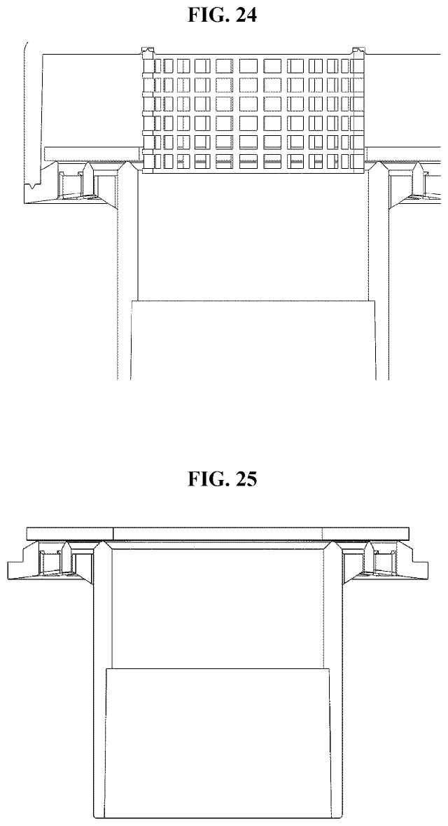

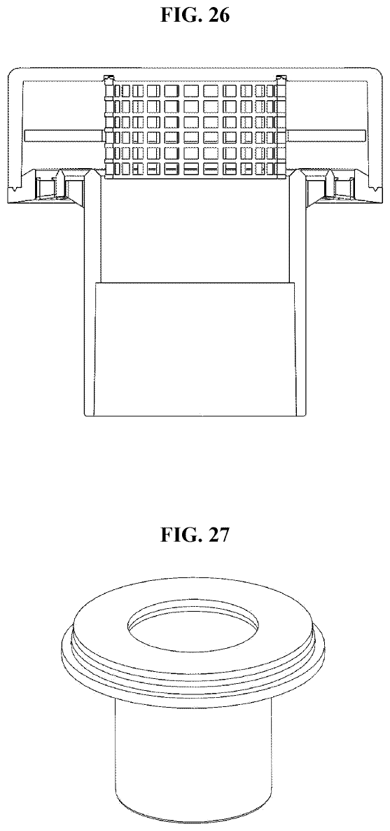

At least one set of sealing ribs project radially from the outer surface of push seal 42 (effectively from the tailpiece 25). In the embodiments shown in FIGS. 5A and 5B, only a single set of sealing ribs 44a, 44b, 44c are present. In the embodiments shown in FIGS. 5C and 5D, a first set of sealing ribs 44a, 44b. 44c are present, in addition to a second set of sealing ribs 46a, 46b, 46c are included. The number of sealing ribs per set may be up to 10, but 2-5 are preferred. The embodiments of FIGS. 5A-5C include three sealing ribs per set. When more than one set of sealing ribs are present, the respective sets may have different numbers of sealing ribs. For example, in the embodiment of FIG. 1B, the first set of sealing ribs 44a, 44b. 44c includes three members, while the second set of sealing ribs 46 include two members.

When more than one set of sealing ribs are present, each set of sealing ribs projects radially from the outer surface of push seal 42 to a distance that is different from the distance to which another set of sealing ribs project. In particular, when more than one set of sealing ribs are present, the set of sealing ribs that is proximate to the bottom end of the push seal 42 projects radially outward to a first distance, and the set of sealing ribs that is more distal to the bottom end of the push seal 42 projects radially outward to a second distance that is greater than the first distance. The purpose of equipping the push seal with respective sets of sealing ribs is to permit use of the push seal with at least two different sizes of pipe or fitting of a DWV system, i.e., to permit the push seal to form a fluid seal with a pipe or fitting of a DWV system having a first inner diameter via a first set of sealing ribs, and to permit the push seal to form a fluid seal with a different pipe or fitting of a DWV system having a second inner diameter that is larger than the inner diameter of the other pipe or fitting via a second set of sealing ribs.

For example, in the embodiment shown in FIG. 5A, the push seal includes sealing ribs 44a, 44b, 44c that project radially from the push seal 42 to define a first sealing diameter that ensures a fluid seal with the inner surface of a pipe having an inner diameter of 40 mm. In the embodiment shown in FIG. 5B, the push seal includes sealing ribs 44a, 44b, 44c that project radially from the push seal 42 to define a first sealing diameter that ensures a fluid seal with the inner surface of a pipe having an inner diameter of 50 mm.

In the embodiments shown in FIGS. 5C and 5D, the push seal includes sealing ribs 44a, 44b. 44c that project radially from the push seal 42 to define a first sealing diameter that ensures a fluid seal with the inner surface of a pipe having an inner diameter of 40 mm, and push seal 42 also includes sealing ribs 46a, 46b. 46c that ensures a fluid seal with the inner surface of a pipe having an inner diameter of 50 mm.

The individual sealing ribs within a particular set need not project from the push seal 42 to precisely the same distance. In fact, it may be advantageous for individual sealing ribs within a particular set to vary in length incrementally. i.e., by a small amount relative to their total length, such as by about 1-4 mm, such as by about 1, 2, 3, or 4 mm. For example, an incremental diameter increase of the sealing ribs from the bottom member to the top member of a particular set can create better sealing, accommodate wider range of DWV pipes/fittings (as the inner diameter may vary slightly from pipe manufacturer to manufacturer even for a given nominal size), and to enhance user experience while pressing the AAV unit down by providing a perception of tighter fit because the increased interference between respectively sealing ribs and the inner surface of the DWV pipe/fitting. Accordingly, in some embodiments, at least some of the individual members of a particular set of sealing ribs may vary in length by about 0.5, 1, 1.5, 2, 2.5, 3, 3.5, 4, 4.5 or 5% relative to one another. In certain embodiments, the individual members vary in length according to their position in the set, for example, such that the bottom-most member of the set (i.e., the member that is the most proximate to the lower end of the tailpiece, and the most distal from the flange of the body portion) has the shortest length, and the top-most member of the set (that is most distal from the lower end of the tailpiece compared to the other members of the set) has the greatest length. In some embodiments, not all of the members of a particular set vary in length relative to one another. For example, some members may have the same length, and such members may vary in length from one or more other members of the set. In one example, a set of sealing ribs having three individual member ribs includes two lowermost ribs that are of the same length, and a third, top rib that varies in length as compared with the first two ribs in that it is 2% longer than the first two ribs. In another example, a set of sealing ribs having three individual member ribs includes a first lowermost rib having a first length, a middle rib having a second length that is longer than the first length by about 2%, and a third, top rib having a third length that is longer than the second length by about 2%.

Table 2, below, provides exemplary sealing diameters defined by the respective sets of sealing ribs of specific embodiments. As shown in the table, each set of sealing ribs includes three separate members that vary in size relative to one another. The first listed member is the bottom-most member of the set (i.e., the member that is the most proximate to the lower end of the tailpiece, and the most distal from the flange of the body portion).

TABLE 2

| | | | |
|---|---|---|---|
| | First | Second | Outer |
| | (Bottom) | (Top) | Diameter of |
| | Sealing | Sealing | Pipe Sealing |
| Embodiment | Diameters | Diameters | Rib |

| | | | | | |
|---|---|---|---|---|---|
| 40 mm/50 mm | 50.0 | mm | 63.0 mm | 75 | mm |
| with groove | 51.5 | mm | 63.5 mm | | |
| | 52.0 | mm | 64.5 mm | | |
| 40 mm/50 mm | 50.0 | mm | 63.0 mm | 75 | mm |
| without | 51.5 | mm | 63.5 mm | | |
| groove | 52.0 | mm | 64.5 mm | | |
| 40 mm | 50.0 | mm | N/A | 62.5 | mm |
| | 51.5 | mm | | | |
| | 52.0 | mm | | | |
| 50 mm | 63.0 | mm | N/A | 75 | mm |
| | 63.5 | mm | | | |
| | 64.5 | mm | | | |
| 100 mm | 100.0 | mm | N/A | 126 | mm |
| | 101.5 | mm | | | |
| | 102.0 | mm | | | |
| 125 mm | 126.0 | mm | N/A | 145 | mm |
| | 127.0 | mm | | | |

Sealing ribs of push seal 42 may have any desired cross-sectional shape. FIGS. SA-5D show sealing ribs 44 having one type of cross-sectional shape. FIGS. 5E-5F show sealing ribs 44 having a different type of cross-sectional shape that is wider and more rectangular than that of the sealing ribs of FIGS. 5A-5D.

Push seal 42 can also include a pipe sealing rib 48 that projects radially from the push seal (effectively from the tailpiece) to a radial distance that is greater than the inner diameter of the pipe or fitting into which the lower portion of push seal 42 is inserted. As depicted in FIB. 1B, which shows an exemplary AAV assembly 1 inserted into a pipe of a DWV system, pipe sealing rib 48 forms a fluid seal at the top edge of the pipe 33b.

When more than one set of sealing ribs are present, one rib of the set of sealing ribs that is more proximate to cap 2 than a first set of sealing ribs may serve to ensure a fluid seal at the top edge of a pipe or fitting with which the first set of sealing ribs is intended to form a fluid seal at the inner surface of the pipe or fitting. For illustrative purposes, FIG. 1B shows a first pipe 33a having a first inner diameter against which the first set of sealing ribs 44a. 44b, 44c form a fluid seal when push seal 42 is inserted therein, and FIG. 1B also shows a second pipe 33b having a second inner diameter (that is greater than the inner diameter of the first pipe 33a) against which the second set of sealing ribs 46 form a fluid seal when push seal 42 is inserted therein. The lower one of the two sealing ribs 46 forms a fluid seal at the top edge of pipe 33a by virtue of the fact that sealing ribs 46 project radially from push seal 42 to a radial distance that is greater than the inner diameter of pipe 33a.

In some embodiments, such as those depicted in FIGS. 5A, 5B. 5D, and 5G, push seal 42 includes a cylindrical inner channel though which tailpiece 25 can be inserted from a top opening of the channel all the way through the opposing bottom opening of the channel. As also shown in FIGS. 5A, 5B. 5D, and 5G, the inner walls of push seal 42 defining the inner channel may include one or more channel ribs 63 that improve sealing between push seal 42 and the outer surface of a tailpiece (not shown).

In other embodiments, such as is depicted in FIGS. 3 and 5C, the inner channel of push seal 42 can include an annular groove 62 into which the distal or lower end of tailpiece 25 is inserted. Such embodiments may optionally include channel ribs 63.

Push seal 42 may be formed from any flexible or semi-rigid material that is capable of forming a seal with the inner face of a pipe or fitting of a DWV system when inserted therein. Suitable materials include a natural or synthetic rubber, silicone, neoprene, or any combination thereof. An exemplary material from which push seal 42 may be formed is ethylene propylene diene monomer (EPDM) rubber.

The AAV assembly 1 according to the present disclosure is configured to permit a beneficially high rate of airflow from the ambient environment outside of tailpiece 25 to within the AAV assembly via air intake openings 36 of flange 30, and through the openings 19 in lattice 16, when the flexible washer is moved to the open position such that it is not resting against air intake ribs 34 of flange 30, i.e., when an air pressure inside of the tailpiece 25 is less than an ambient pressure outside of the AAV assembly 1. The amount of airflow enabled by the presently disclosed configurations is greater than currently commercially available air admittance valve assemblies. In order to ensure the desired amount of airflow, in some embodiments, the AAV assembly 1 is configured such that the total area of the lattice openings 19 is greater than or equal to the cross-sectional area of the tailpiece. In some embodiments, the AAV assembly 1 is configured such that the total area of the air intake openings 36 of flange 30 is greater than or equal to the cross-sectional area of the tailpiece.

In some embodiments, the airflow into the AAV assembly 1 according to the present disclosure is more than about 8 L/s when the flexible washer is moved to the open position. For example, the airflow may be about 8-40 L/s when the flexible washer is moved to the open position, such as about 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 L/s when the flexible washer is moved to the open position. The airflow may vary according to the size of the tailpiece being used. For example, in one embodiment, where the tailpiece is adapted for use with a 50 mm DWV pipe or fitting, the airflow may be closer to about 8 L/s. In other embodiments, where the tailpiece is adapted for use with an 80 mm DWV pipe or fitting, the airflow may be closer to about 35 L/s.

1. An air admittance valve assembly comprising:
a cap that includes
(i) a top side,
(ii) an underside,
(iii) a cap wall having a top end that extends from an outer periphery of the top side, a bottom edge that defines a terminal end of the cap wall, an inner radial face, and an outer radial face, and (iv) a lattice comprising lattice struts, lattice openings representing void spaces between the lattice struts, a top edge that extends from the underside of the cap, a bottom edge that is spaced apart from the top edge, and a lattice wall extending between the top edge and the bottom edge, the lattice extending about the underside of the cap concentrically with the cap wall;
a body portion that includes
(i) a tailpiece that includes a bottom end, a top end, and a middle portion extending between the bottom end and the top end, the tailpiece having a diameter that is sized for insertion into a pipe or fitting of a drain, waste, and vent system, and
(ii) a flange extending radially from the top end of the tailpiece, wherein the flange comprises a top surface, a bottom surface, an edge extending between the top surface and the bottom surface, a cap seat positioned at an outer periphery of the top surface adjacent to the edge for engaging the bottom edge of the cap wall in a sealing manner, and an air intake comprising air intake ribs, air intake openings extending through the flange from the bottom surface to the top surface and defined as void spaces between air intake ribs, at least some of the air intake ribs including valve seat members at the top surface of the flange; and,
a flexible washer having bottom face, a top face, an outer concentric edge extending between the top and bottom faces, and an inner concentric edge that defines a central void and extends between the top and bottom faces,
wherein when a pressure inside of the tailpiece is not less than an ambient pressure outside of the air admittance valve assembly, the flexible washer is seated on the top surface of the flange, such that the bottom face of the flexible washer contacts the valve seat members and thereby prevents fluid communication between the inside of the tailpiece and the ambient environment outside of the air admittance valve assembly via the air intake openings of the flange, and,
wherein when a pressure inside of the tailpiece is less than an ambient pressure outside of the air admittance valve assembly, the flexible washer is raised in a direction that is guided by contact of the outer concentric edge with the inner radial face of the cap wall, that is guided by contact of the inner concentric edge with lattice wall, or both, and thereby permits fluid communication between the inside of the tailpiece and the ambient environment outside of the air admittance valve assembly via the air intake openings of the flange.

2. (canceled)

3. The air admittance valve assembly according to claim 1, where the total area of the lattice openings is greater than or equal to the cross-sectional area of the tailpiece, or the total area of the air intake openings of the flange is greater than or equal to the cross-sectional area of the tailpiece.

4. (canceled)

5. (canceled)

6. (canceled)

7. The air admittance valve assembly according to claim 1, wherein the top edge of the lattice is integral with the underside of the cap.

8. The air admittance valve assembly according to claim 1, further comprising a push seal that is mounted on the bottom end of the tailpiece and comprises
(i) a first set of sealing ribs positioned at a distal portion of the push seal, each of said first set of sealing ribs projecting radially from the tailpiece to define a first sealing diameter that ensures a fluid seal between the first set of sealing ribs and an inner surface of a pipe or fitting of a drain, waste, and vent system having a first inner diameter when the tailpiece is inserted therein;
(ii) a second set of sealing ribs positioned at a proximal portion of the push seal, each of said second set of sealing ribs projecting radially from the tailpiece to define a second sealing diameter that is greater than the first sealing diameter and ensures a fluid seal between the second set of sealing ribs and an inner surface of a pipe or fitting of a drain, waste, and vent system having a second inner diameter that is greater than the first inner diameter when the tailpiece is inserted therein.

9. The air admittance valve assembly according to claim 8, further comprising a pipe sealing rib extending radially from the tailpiece to define a third sealing diameter that is greater than the second sealing diameter and ensures a fluid seal at a top edge of the pipe or fitting of a drain, waste, and vent system having a second inner diameter.

10. The air admittance valve assembly according to claim 8, wherein one rib of the second set of sealing ribs ensures a fluid seal at a top edge of the pipe or fitting of a drain, waste, and vent system having a first inner diameter.

11. The air admittance valve assembly according to claim 1, wherein the flexible washer further comprises a carrier ring that is removably affixed to the inner circumferential edge of the flexible washer.

12. The air admittance valve assembly according to claim 1, wherein the flexible washer further comprises one or more substantially rigid support rings on the top face of the flexible washer.

13. An air admittance valve assembly comprising:
a cap that includes
(i) a top side,
(ii) an underside, and,
(iii) a cap wall having a top end that extends from an outer periphery of the top side, a bottom edge that defines a terminal end of the cap wall, an inner radial face, and an outer radial face,
a body portion that includes
(i) a tailpiece that includes a bottom end, a top end, and a middle portion extending between the bottom end and the top end, the tailpiece having a diameter that is sized for insertion into a pipe or fitting of a drain, waste, and vent system, and
(ii) a flange extending radially from the top end of the tailpiece, wherein the flange comprises a top surface, a bottom surface, an edge extending between the top surface and the bottom surface, a cap seat positioned at an outer periphery of the top surface adjacent to the edge for engaging the bottom edge of the cap wall in a sealing manner, and an air intake comprising air intake ribs, air intake openings extending through the flange from the bottom surface to the top surface and defined as void spaces between air intake ribs, at least some of the air intake ribs including valve seat members at the top surface of the flange;
a flexible washer having bottom face, a top face, an outer concentric edge extending between the top and bottom faces, and an inner concentric edge that defines a central void and extends between the top and bottom faces, and,
a push seal that is mounted on the bottom end of the tailpiece and comprises
(i) a first set of sealing ribs positioned at a distal portion of the push seal, each of said first set of sealing ribs projecting radially from the tailpiece to define a first sealing diameter that ensures a fluid seal between the first set of sealing ribs and an inner surface of a pipe or fitting of a drain, waste, and vent system having a first inner diameter when the tailpiece is inserted therein;
(ii) a second set of sealing ribs positioned at a proximal portion of the push seal, each of said second set of sealing ribs projecting radially from the tailpiece to define a second sealing diameter that is greater than the first sealing diameter and ensures a fluid seal between the second set of sealing ribs and an inner surface of a pipe or fitting of a drain, waste, and vent system having a second inner diameter that is greater than the first inner diameter when the tailpiece is inserted therein,
wherein when a pressure inside of the tailpiece is not less than an ambient pressure outside of the air admittance valve assembly, the flexible washer is seated on the top surface of the flange, such that the bottom face of the flexible washer contacts the valve seat members and thereby prevents fluid communication between the inside of the tailpiece and the ambient environment outside of the air admittance valve assembly via the air intake openings of the flange, and,
wherein when a pressure inside of the tailpiece is less than an ambient pressure outside of the air admittance valve assembly, the flexible washer is raised in a direction that is guided by contact of the outer concentric edge with the inner radial face of the cap wall, that is guided by contact of the inner concentric edge with lattice wall, or both, and thereby permits fluid communication between the inside of the tailpiece and the ambient environment outside of the air admittance valve assembly via the air intake openings of the flange.

14. The air admittance valve assembly according to claim 13, where the total area of the air intake openings of the flange is greater than or equal to the cross-sectional area of the tailpiece.

15. (canceled)

16. (canceled)

17. The air admittance valve assembly according to claim 13, further comprising a pipe sealing rib extending radially from the tailpiece to define a third sealing diameter that is greater than the second sealing diameter and ensures a fluid seal at a top edge of the pipe or fitting of a drain, waste, and vent system having a second inner diameter.

18. The air admittance valve assembly according to claim 13, wherein one rib of the second set of sealing ribs ensures a fluid seal at a top edge of the pipe or fitting of a drain, waste, and vent system pipe having a first inner diameter.

19. The air admittance valve assembly according to claim 13, wherein the flexible washer further comprises a carrier ring that is removably affixed to the inner circumferential edge of the flexible washer.

20. The air admittance valve assembly according to claim 13, wherein the flexible washer further comprises one or more substantially rigid support rings on the top face of the flexible washer.

21. An air admittance valve assembly comprising:
a cap that includes
(i) a top side,
(ii) an underside, and,
(iii) a cap wall having a top end that extends from an outer periphery of the top side, a bottom edge that defines a terminal end of the cap wall, an inner radial face, and an outer radial face,
a body portion that includes
(i) a tailpiece that includes a bottom end, a top end, and a middle portion extending between the bottom end and the top end, the tailpiece having a diameter that is sized for insertion into a pipe or fitting of a drain, waste, and vent system, and
(ii) a flange extending radially from the top end of the tailpiece, wherein the flange comprises a top surface, a bottom surface, an edge extending between the top surface and the bottom surface, a cap seat positioned at an outer periphery of the top surface adjacent to the edge for engaging the bottom edge of the cap wall in a sealing manner, and an air intake comprising air intake ribs, air intake openings extending through the flange from the bottom surface to the top surface and defined as void spaces between air intake ribs, at least some of the air intake ribs including valve seat members at the top surface of the flange; and,
a flexible washer having bottom face, a top face, an outer concentric edge extending between the top and bottom faces, and an inner concentric edge that defines a central void and extends between the top and bottom faces,
wherein when a pressure inside of the tailpiece is not less than an ambient pressure outside of the air admittance valve assembly, the flexible washer is seated on the top surface of the flange, such that the bottom face of the flexible washer contacts the valve seat members and thereby prevents fluid communication between the inside of the tailpiece and the ambient environment outside of the air admittance valve assembly via the air intake openings of the flange,
wherein when a pressure inside of the tailpiece is less than an ambient pressure outside of the air admittance valve assembly, the flexible washer is raised in a direction that is guided by contact of the outer concentric edge with the inner radial face of the cap wall, that is guided by contact of the inner concentric edge with lattice wall, or both, and thereby permits fluid communication between the inside of the tailpiece and the ambient environment outside of the air admittance valve assembly via the air intake openings of the flange, and,
wherein the total area of the air intake openings of the flange is greater than or equal to the cross-sectional area of the tailpiece.

22. The air admittance valve assembly according to claim 21, wherein the cap further comprises
a lattice comprising lattice struts, lattice openings representing void spaces between the lattice struts, a top edge that extends from the underside of the cap, a bottom edge that is spaced apart from the top edge,
and a lattice wall extending between the top edge and the bottom edge, the lattice extending about the underside of the cap concentrically with the cap wall.

23. (canceled)

24. The air admittance valve assembly according to claim 22, where the total area of the lattice openings is greater than or equal to the cross-sectional area of the tailpiece.

25. The air admittance valve assembly according to claim 21, wherein the flexible washer further comprises a carrier ring that is removably affixed to the inner circumferential edge of the flexible washer.

26. The air admittance valve assembly according to claim 21, wherein the flexible washer further comprises one or more substantially rigid support rings on the top face of the flexible washer.

27. A method for selectively admitting air into a plumbing system comprising inserting a portion of an air admittance valve assembly according to claim 1 into an open end of a pipe of the plumbing system, whereby said insertion forms a seal between the air admittance valve assembly and the end of the pipe.
